(19) United States
(12) Patent Application Publication
(10) Pub. No.: US 2004/0138347 A1
(43) Pub. Date: Jul. 15, 2004

(54) Process for the preparation of rice hulls impregnated with oil fat grease usefulas fillers for resins

(76) Inventors: Arno Ernest Keller, Porto Alegre (BR); Ivo AntonioBarcellos Steigleder, Porto Alegre (BR); Joao Nadir Franco De Lima, Porto Alegre (BR)

Correspondence Address: Clifford H Kraft, 320 Robin Hill Drive, Naperville, IL, 60540, US

(21) Appl. No.: 10/466,238

(22) PCT Filed: Jan. 18, 2002
(86) PCT No.: PCT/BR02/00011

(30) Foreign Application Priority Data
Jan. 26, 2001 (BR) PI01004190

(51) Int. Cl. C08J 3/00; C08K 11/00

(52) U.S. Cl. 524/15

(57) ABSTRACT

One submits rice outer covering to a grinding process (01), next to a drying process (02), passing then through a sprayer (03) where one mixes from 2 to 10% of oil, mineral and/or vegetal and/or animal, mineral or vegetal fat to the dry rice outer covering, which goes on being transported towards the mixer (04), next towards the resin mixer (05), where one can add mineral and/or vegetal oils, greases and/or animal, mineral and/or vegetal fats, plastifiers, pigments etc., being after submitted to heating (06) and next to a final molding process (07).

The present descriptive report of the invention patent refers to a process for preparation of rice outer covering, so that we can inhibit the production of gases when it is warmed, in order to make possible a mixture with thermoplastic or thermofixed resin.

Until now nobody could utilize rice outer covering, abundant material at the process units, and of hard utilization and elimination, due to the fact that, when it is warmed so that it can be mixed with resin, it liberates gases which contaminate the resin and prevent such adherence.

By adding 2 to 10% of oil, mineral and/or vegetal, and/or fat and animal, mineral or vegetal grease to dry rice outer covering, ground or not, one prevents the liberation of gases, and, by aggregating to the plastic vehicles (resins), depending on the mixture and on the grade of grinding, one can obtain products with various characteristics.

Adding of oil and/or grease and/or fat is extremely important, since rice outer covering does not liberate gases any more when it is warmed and mixed with the resin(s).

The proportion of outer covering-resin is determined by the characteristics of desired product, its mechanical resistance, flexibility and so on.

Through the described process one can produce boards, wall wainscots, stakes, vessels, molded pieces in general, such as container platforms etc.

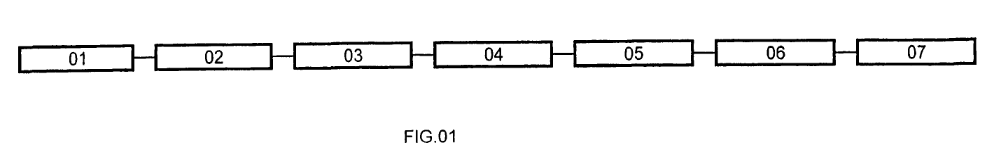

In order to propitiate a better comprehension of the explanation, we represented the present process object in FIG. 01-Diagram in blocks.

As one can observe in the drawing, rice outer covering is initially submitted to the grinding process (01) micronizing it according the necessity and the product to be produced. Next, rice outer covering is submitted to a drying process (02) through hot air, forced ventilation, air friction or other means, being completely dry in 30-40 minutes, reaching a temperature of 70-80 degrees Celsius, attaining a minimum of humidity, being then transported through a continuous conveyor belt or any other continuous means, passing through sprayers (03) that mix from 2 to 10% of oil, mineral and/or vegetal, and/or fat or animal, mineral or vegetal grease on the dry rice outer covering, that goes on being transported towards the mixer (04) that can be by tumbling barrels or any other means, wher it will be maintained for about two hours in order to allow perfect homogenization.

Rice covering can also be ground after it leaves the mixer (04).

Next, it enters the resin mixer (05). There one can also add about 2% of mineral, vegetal or animal oils and plastifiers, fats and mineral, vegetal and animal greases, calcium carbonate, industrial talcum, dyes, pigments etc. Following, it is submitted to heating (06) and to the final conformation process (07).

CLAIMING “PROCESS FOR PREPARATION OF RICE OUTER COVERING TO BE UTILIZED WITH RESINS”, characterized by the rice outer covering submission to a grinding process (01), next passing through a drying process (02) for about 30-40 minutes, reaching a 70-80 degree Celsius temperature, being transported along sprayers (03) of mineral and/or vegetal oil and/or fat or animal, mineral or vegetal grease through a continuous conveyor belt and following taken to the mixer (04) where it is maintained for about two hours, being the rice outer covering also ground after it leaves the mixer (04), being then transported towards the resin mixer (05), being there added mineral and/or vegetal oils, animal, mineral and/or vegetal greases or fats, plastifiers, pigments, etc., next submitted to heating (06) and then suffering a conformation process (07) receiving the resin about 2% of oil.

Depending on the formulation, one obtains raw material that can be submitted to extrusion, injection, blowing, rotomolding, thermomolding or any other process.

In the de extrusion and blowing processes, the temperature of the cycle is different from the usual processes. One starts with higher temperature in the first zone, lowering in the other zones inclusively the head.

1. “PROCESS FOR PREPARATION OF RICE OUTER COVERING TO BE UTILIZED WITH RESINS”, characterized by the rice outer covering submission to a grinding process (01), next passing through a drying process (02) for about 30-40 minutes, reaching a 70-80 degree celsius temperature, being transported along sprayers (03) of mineral and/or vegetal oil and/or fat or animal, mineral or vegetal grease through a continuous conveyor belt and following taken to the mixer (04), where it is maintained for about two hours, being the rice outer covering also ground after it leaves the mixer (04), being then transported towards the resin mixer (05), being there added mineral and/or vegetal oils, animal, mineral and/or vegetal greases or fats, plastifiers, pigments, etc., next submitted to heating (06) and then suffering a conformation process (07) receiving the resin about 2% of oil.
